(19) United States
(12) Patent Application Publication
(10) Pub. No.: US 2004/0057236 A1
(43) Pub. Date: Mar. 25, 2004

(54) Push-in type lamp holder

(76) Inventor: Jeng-shyong Wu, Shinchu (TW)

Correspondence Address: BRUCE H. TROXELL, SUITE 1404, 5205 LEESBURG PIKE, FALLS CHURCH, VA, 22041, US

(21) Appl. No.: 10/251,997

(22) Filed: Sep. 23, 2002

(51) Int. Cl. F21V 33/00

(52) U.S. Cl. 362/253

(57) ABSTRACT

A push-in type lamp holder, comprising: a lamp holder body, an inner seat, and an illuminating apparatus. By using the hollow portions that formed in the central part of the inner seat and the lamp holder body, the illuminating apparatus can be set firmly, and the object for effective and rapid lodging and engaging of the illuminating apparatus with the lamp holder is achieved, and the circuit of the electrical loop is formed.

### BACKGROUND OF THE INVENTION

1. Field of the Invention

The present invention relates to a push-in type lamp holder, and especially to a push-in type lamp holder of which an illuminating apparatus is inserted into an inner seat of the lamp holder. With the projecting rim and the neck portion, the inner seat can be mounted to the hollow portion of the main lamp holder body, thus the object for effective and rapid lodging and engaging of the illuminating apparatus with the lamp holder is achieved, and the circuit of the electrical loop is formed and the illumination is completed.

2. Description of the Prior Art

The conventional lamp holder, as shown in FIG. 1, comprises a lamp holder body 100, a hollow portion 140, a positive conductor 180, and a negative conductor 160. While the rear end of the illuminating apparatus 200 is formed with a spiral-shaped metal portion 220 and a connection point 210, and is engaged with the spiral-shaped hollow portion 140 of the lamp holder body 100. And the positive and negative conductors 160 and 180 are applied to contact with the connection point 210 and the spiral-shaped metal portion 220 of the illuminating apparatus 200, respectively, in order to form the electrical loop and complete the illumination.

The said lamp holder has a certain function, however it has the following disadvantages:

The twirling of the spiral metal portion 220 into the hollow portion 140 of the lamp holder body 100 is a time-consuming process, and it is not beneficial for the economic purpose. Besides, the human body is easily to be cut by the sharp edge of metal portion.

The positive and negative conductors 160 and 180 in the conventional lamp holder body 100 are exposed to air, so that they are easily to be oxidized, and thus the contact of the positive and negative conductors 160 and 180 with the illuminating apparatus is insufficient.

In order to improve aforementioned defects, the inventor of the present invention has made a great effort and disclosed many novel designs, eventually this invention of a push-in type lamp holder is obtained.

### SUMMARY OF THE INVENTION

Accordingly, the present invention is to provide a push-in type lamp holder, by setting an inner seat into a hollow portion of the lamp holder body, the loop of electrical circuit is formed rapidly. This is the first object of the present invention.

According to this push-in type lamp holder of the present invention, With the projecting rim and the neck portion of the inner seat, the above-mentioned inner seat may be mounted to the hollow portion of the main lamp holder body, thus the illuminating apparatus is set firmly and effectively This is another object of the present invention.

According to this push-in type lamp holder of the present invention, by the composition of the lamp holder body, the inner seat, and the illuminating apparatus, it is much easier to maintain and exchange the components of the lamp holder, and the costs of producing and repairing of the lamp holder may be reduced. This is another object of the present invention.

A more complete understanding of these and other features and advantages of the present invention will be apparent from a careful consideration of the following detailed description of certain embodiments illustrated in the accompanying drawings.

### BRIEF DESCRIPTION OF THE DRAWINGS

The accompanying drawing,

FIG. 1 is a sectional view of the structure of the conventional lamp holder.

FIG. 2A is an elevational view in section of the push-in type lamp holder of the present invention.

FIG. 2B is an elevational view in section of the structure of the illuminating apparatus of the present invention.

FIG. 2C is an elevational view in section of the structures of the illuminating apparatus and inner seat of the present invention.

FIG. 2D is a cross-sectional view showing the first embodiment of the combination of present invention.

FIG. 2E is a cross-sectional view showing the second embodiment of the combination of present invention.

FIG. 3 is an assembled longitudinal sectional view of the embodiment of the push-in type lamp holder of the present invention.

### DETAILED DESCRIPTION OF THE PREFERRED EMBODIMENT

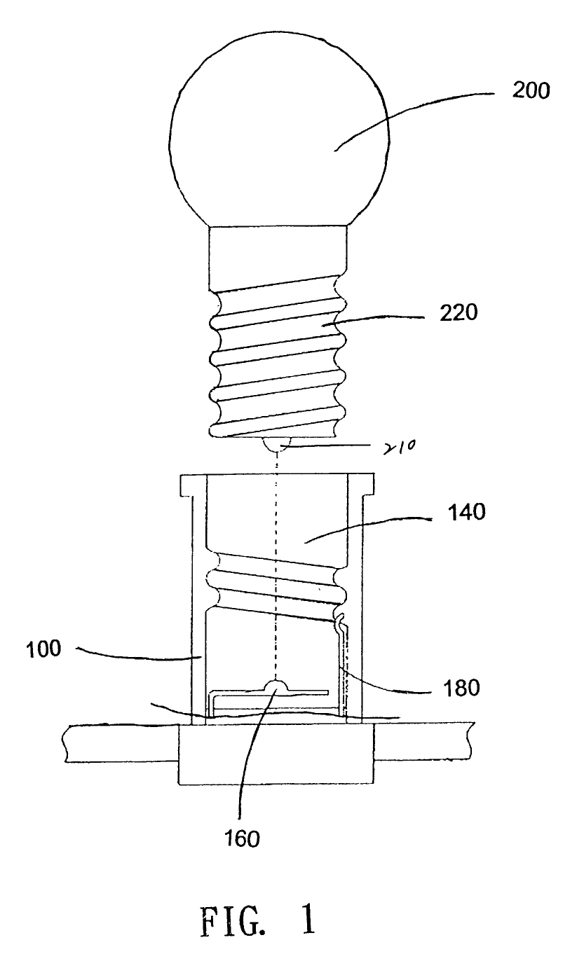

FIG. 1 is a sectional view of the structure of the conventional lamp holder; its functions and disadvantages are described above, and will not be repeated here with.

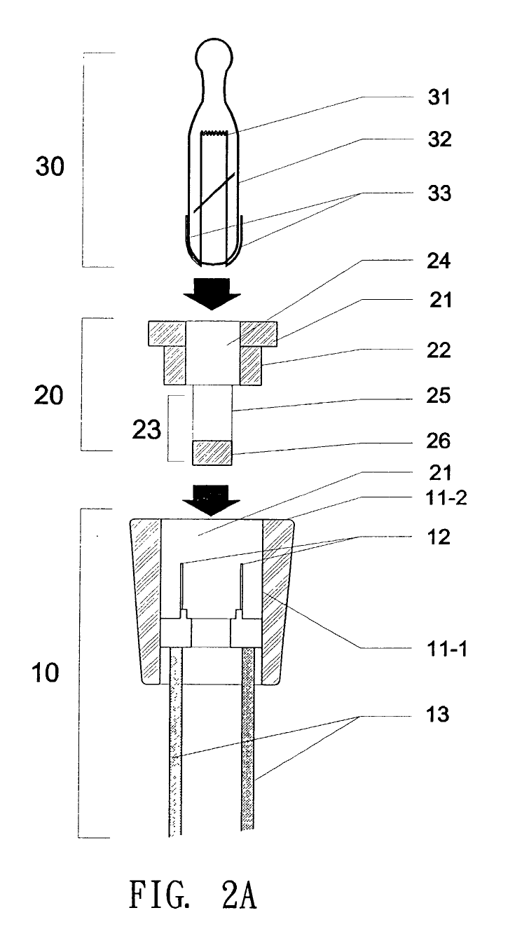

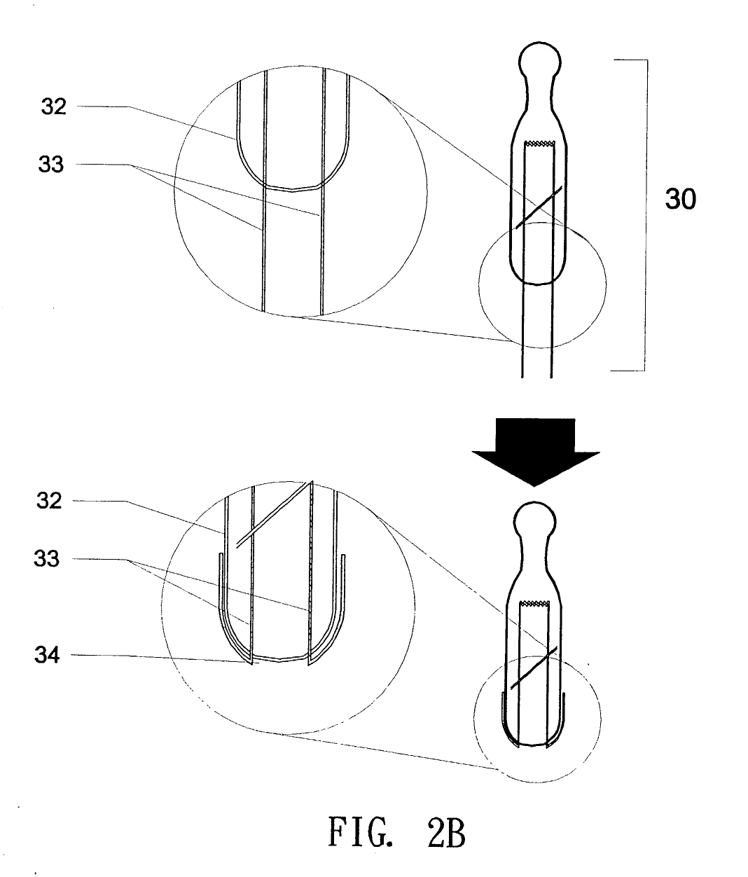

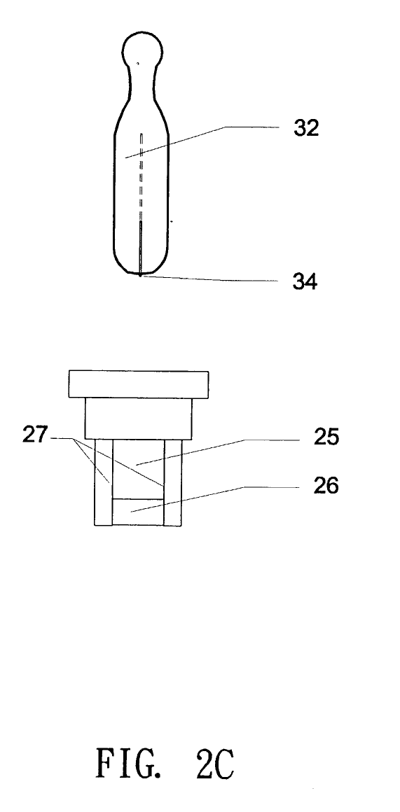

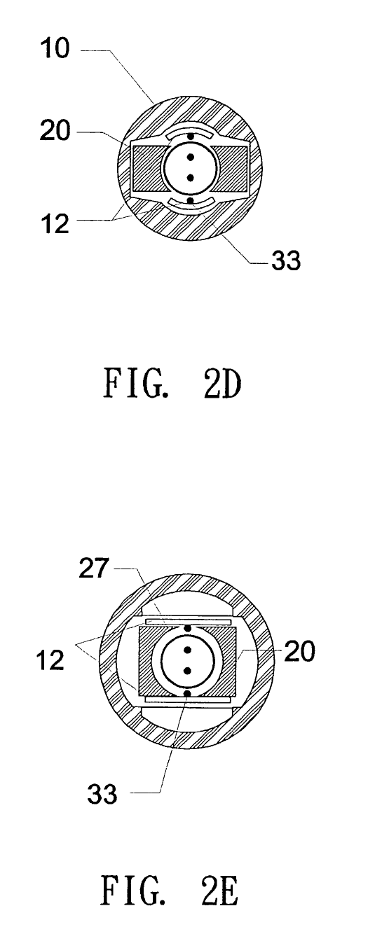

FIG. 2A is an elevational view in section of the push-in type lamp holder of the present invention; the push-in type lamp holder of the present invention consists of:

A lamp holder body 10 of hollow tubing shape, the central part of the lamp holder body 10 is a hollow portion 11 having three sections, and the diameter of hollow portion 11 is close to the neck portion 22 of inner seat 20, so that the neck portion 22 of inner seat 20 can be mounted to the hollow portion 11 of the lamp holder body 10.

Inside of the lamp holder body 10, a plurality of connecting plates 12 connected with a plurality of conducting wires 13 are set in the hollow portion 11 respectively with an inner edge 11-1 of hollow portion 11. The rear ends of said multiple conducting wires 13 extend outward from the bottom of the hollow portion 11 of the lamp holder body 10.

An inner seat 20, which is composed of a projecting rim 21, a neck portion 22, and a bottom portion 23. The diameter of a projecting rim 21 is a bit larger than the hollow portion 11 of a lamp holder body 10 so that when a inner seat 20 is mounted to the lamp holder body 10, said inner seat 20 can be engaged with the lamp holder 10 with the projecting rim 21 positioned on the upper and of the lamp holder body 10; the central part of the inner seat 20 is a hollow portion 24 which connects the openings 25 formed on the lateral of bottom portion 23, the bottom portion 23 forms a base holder 26 for holding illuminating apparatus 20 (as shown in FIG. 2C).

An illuminating apparatus 30, wherein the illuminator 31 is tightly air sealed in a diaphanous husk 32. The illuminator 31 may be made of LED or tungsten filaments and connected with a plurality of filaments 33 to its rear end; before the illuminating apparatus 30 is inserted into the hollow portion 24 of the inner seat 20, a plurality of filaments 33 are bending along the lateral of the diaphanous husk 32 and form a base portion 34 for the illuminating apparatus 30. The said filaments 33 are bent along the surface of husk 32 as shown in FIG. 2B.

FIGS. 2D and 2E are the first and the second embodiment of the connecting plates 12 of the present invention. As shown in the figures, the connecting plates 12 can be formed of rectangle shape (as shown in FIG. 2D), or arc shape (as shown in FIG. 2E). In addition, the inner lateral 27 of the opening 25 of the inner seat 20 is greater than the diameter of the illuminating apparatus 30, but not greater than the outer rim of the filaments 33, thus the filaments 33 won't tilt and an electrical loop of circle can be formed.

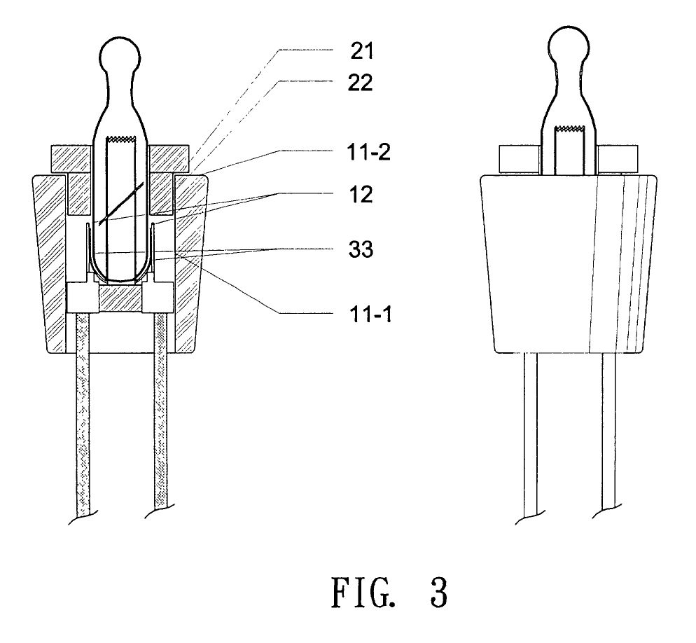

FIG. 3 is the assembled sectional view of the embodiment of the push-in type lamp holder of the present invention. As shown in the drawing, wherein the inner seat 20 with the illuminating apparatus 30 is inserted in the hollow portion 11 of a lamp holder body 10 to make the projecting rim 21 of inner seat 20 contacted with a upper edge 11-2 of a hollow portion 11, so that the inner seat 20 is fixed in the hollow portion 11 of a lamp holder body 10. In addition, the husk 32 and base portion 34 of illuminating apparatus 30 are inserted in the bottom portion 23 of an inner seat 20. A plurality of filaments 33 which stretch out of the openings 25 on the lateral of the base portion 34 of a illuminating apparatus 30, are bending along the lateral of the husk 32. Besides, the said filaments 33 exposed on the lateral of the illuminating apparatus are contacted with connecting plates 12 respectively to form an electrical loop of circuit, and finally the lamp is illustrated as the electricity is applied

By the construction described above, the engaging of the illuminating apparatus with the lamp holder can be easily achieved, and the circuit of the electrical loop is formed.

Although the present invention has been described with a certain degree of particularity, the present disclosure has been made by way of example and change in details of structure may be made without departing from the spirit thereof.

What is claimed is:

1. A push-in type lamp holder, comprising:
a lamp holder body, which is made of insulating material, the central part of said lamp holder body is a hollow portion; a plurality of connecting plates, are set in the lateral of said hollow portion of the lamp holder body, and mounted with a plurality of conducting wires, respectively; said multiple conducting wires are extending outward from the bottom of the hollow portion of the lamp holder body;
an inner seat, the central part of the inner seat is a hollow portion which connects the openings formed on the lateral of bottom portion;
an illuminating apparatus, which is composed of an illuminator and a plurality of filaments, is sealed in a diaphanous husk; said plurality of filaments which stretch out of the openings on the lateral of the bottom portion of a illuminating apparatus, are bending along the lateral of the husk;
wherein, said illuminating apparatus is mounted to the bottom of the hollow portion of the inner seat, so that the filament is exposed to the opening on the lateral of the bottom portion of the inner seat;
while the inner seat, which carries the illuminating apparatus, is inserted in the hollow portion of the lamp holder body, and the filaments on the lateral of the illuminating apparatus are connected with said multiple connecting plates, thus the circuit of the electrical loop is formed.

2. A push-in type lamp holder, comprising:
a lamp holder body, that is made of insulating material, the central part of said lamp holder body is a hollow portion having three sections, a plurality of connecting plates, which are set in the lateral of said hollow portion of the lamp holder body, and connected with a plurality of conducting wires respectively;
said multiple conducting wires are extending outward from the bottom of the hollow portion of the lamp holder body;
an inner seat, which is composed of three parts: a projecting rim, a neck portion, and a bottom portion; the diameter of said projecting rim is a bit larger than the hollow portion of a lamp holder body; a hollow portion, which links the hollow portion in the projecting rim, is formed at the center of the neck portion; and a base holder, is mounted to said bottom portion; furthermore, a pair of openings that formed on the lateral of said bottom portion, are connected with the hollow portion at the center of the neck portion; and
an illuminating apparatus, which composed of an illuminator and a plurality of filaments, is sealed in a diaphanous husk; and end of said filament is mounted to the illuminator; the other end of the filament that stretches out of the openings on the lateral of said base portion of the illuminating apparatus, is bending along the lateral of the husk;
said illuminating apparatus is inserted in the bottom of the hollow portion of the inner seat, so that the filament is exposed to the opening on the lateral of the bottom portion of the inner seat.
said inner seat, which carries the illuminating apparatus, is set in the hollow portion of the lamp holder body, and the filaments on the lateral of the illuminating apparatus are connected with said multiple connecting plates, thus the circuit of the electrical loop is formed.

3. The push-in type lamp holder as claimed in claim 1, wherein the inner lateral of the hollow portion of the inner seat is greater than the diameter of the illuminating apparatus, but not greater than the outer rim of the filaments.

4. The push-in type lamp holder as claimed in claim 1, wherein the multiple connecting plates are formed in arc shape.

5. The push-in type lamp holder as claimed in claim 1, wherein the illuminator is made of LED or tungsten filaments.

6. The push-in type lamp holder as claimed in claim 1, wherein the husk is made of diaphanous or colorized materials.

7. The push-in type lamp holder as claimed in claim 1, wherein the husk is formed in cylindrical shape, or circular shape, or other prescribed shapes.

8. The push-in type lamp holder as claimed in claim 2, wherein the inner lateral of the hollow portion of the inner seat is greater than the diameter of the illuminating apparatus, but not greater than the outer rim of the filaments.

9. The push-in type lamp holder as claimed in claim 2, wherein the multiple connecting plates are formed in arc shape.

10. The push-in type lamp holder as claimed in claim 2, wherein the illuminator is made of LED or tungsten filaments.

11. The push-in type lamp holder as claimed in claim 2, wherein the husk is made of diaphanous or colorized materials.

12. The push-in type lamp holder as claimed in claim 2, wherein the husk is formed in cylindrical shape, or circular shape, or other prescribed shapes.
